(19) United States
(12) Patent Application Publication
(10) Pub. No.: US 2009/0234687 A1
(43) Pub. Date: Sep. 17, 2009

(54) METHOD OF DESIGNING AN OPTICAL METROLOGY SYSTEM OPTIMIZED FOR OPERATING TIME BUDGET

(75) Inventors: XINKANG TIAN, SAN JOSE, CA (US); EDRIC TONG, SUNNYVALE, CA (US); CHING-LING MENG, SUNNYVALE, CA (US); MIHAIL MIHALOV, SAN JOSE, CA (US); MANUEL MADRIAGA, SAN JOSE, CA (US)

Correspondence Address: Tokyo Electron U.S. Holdings, Inc., 4350 West Chandler Blvd., Suite 10/11, Chandler, AZ, 85226, US

(73) Assignee: TOKYO ELECTRON LIMITED, TOKYO (JP)

(21) Appl. No.: 12/050,053

(22) Filed: Mar. 17, 2008

(51) Int. Cl. G06Q 10/00; G06F 17/00

(52) U.S. Cl. 705/7

(57) ABSTRACT

Provided is a method of designing an optical metrology system for measuring structures on a workpiece wherein the optical metrology system is configured to achieve a time budget for completing metrology process steps. The design of the optical metrology system is optimized by using collected operating data in comparison to the selected operating criteria. In one embodiment, the optical metrology system is used for stand alone systems. In another embodiment, the optical metrology system is integrated with fabrication clusters in semiconductor manufacturing.

### BACKGROUND

1. Field

The present application generally relates to the design of an optical metrology system to measure a structure formed on a workpiece, and, more particularly, to optimizing the design of an optical metrology system to meet operating time budget in completing metrology steps.

2. Related Art

Optical metrology involves directing an incident beam at a structure on a workpiece, measuring the resulting diffraction signal, and analyzing the measured diffraction signal to determine various characteristics of the structure. The workpiece can be a wafer, a substrate, or a magnetic medium. In manufacturing of the workpieces, periodic gratings are typically used for quality assurance. For example, one typical use of periodic gratings includes fabricating a periodic grating in proximity to the operating structure of a semiconductor chip. The periodic grating is then illuminated with an electromagnetic radiation. The electromagnetic radiation that deflects off of the periodic grating is collected as a diffraction signal. The diffraction signal is then analyzed to determine whether the periodic grating, and by extension whether the operating structure of the semiconductor chip, has been fabricated according to specifications.

In one conventional system, the diffraction signal collected from illuminating the periodic grating (the measured diffraction signal) is compared to a library of simulated diffraction signals. Each simulated diffraction signal in the library is associated with a hypothetical profile. When a match is made between the measured diffraction signal and one of the simulated diffraction signals in the library, the hypothetical profile associated with the simulated diffraction signal is presumed to represent the actual profile of the periodic grating. The hypothetical profiles, which are used to generate the simulated diffraction signals, are generated based on a profile model that characterizes the structure to be examined. Thus, in order to accurately determine the profile of the structure using optical metrology, a profile model that accurately characterizes the structure should be used.

With increased requirement for throughput, decreasing size of the structures, and lower cost of ownership, there is greater need to optimize design of optical metrology systems to meet a time budget for completing the metrology steps.

### SUMMARY

Provided is a method of designing an optical metrology system for measuring structures on a workpiece wherein the optical metrology system is configured to achieve a time budget for completing metrology process steps. The design of the optical metrology system is optimized by using collected time data in comparison to the selected operating time budget. In one embodiment, the optical metrology system is used for standalone systems. In another embodiment, the optical metrology system is integrated with fabrication clusters in semiconductor manufacturing.

### BRIEF DESCRIPTION OF DRAWINGS

FIG. 1A is an architectural diagram illustrating an exemplary embodiment where an optical metrology system can be utilized to determine the profiles of structures formed on a semiconductor wafer.

FIG. 1B depicts an exemplary optical metrology system in accordance with embodiments of the invention.

FIG. 2 depicts an exemplary flowchart for designing an optical metrology system for extracting structure profile parameters and controlling a fabrication process.

FIG. 3 depicts an exemplary flowchart for designing a sub-system of the optical metrology system for extracting structure profile parameters.

FIG. 4 depicts an exemplary flowchart for optimizing the design of an optical metrology system based on a metrology time budget.

FIG. 5 depicts an exemplary flowchart for developing and optimizing the time needed to complete an optical metrology measurement process.

FIG. 6 is an exemplary block diagram of a system to optimize the time needed to complete an optical metrology measurement process.

### DETAILED DESCRIPTION OF EXEMPLARY EMBODIMENT(S)

In order to facilitate the description of the present invention, a semiconductor wafer may be utilized to illustrate an application of the concept. The methods and processes equally apply to other workpieces that have repeating structures. The workpiece may be a wafer, a substrate, disk, or the like. Furthermore, in this application, the term structure when it is not qualified refers to a patterned structure.

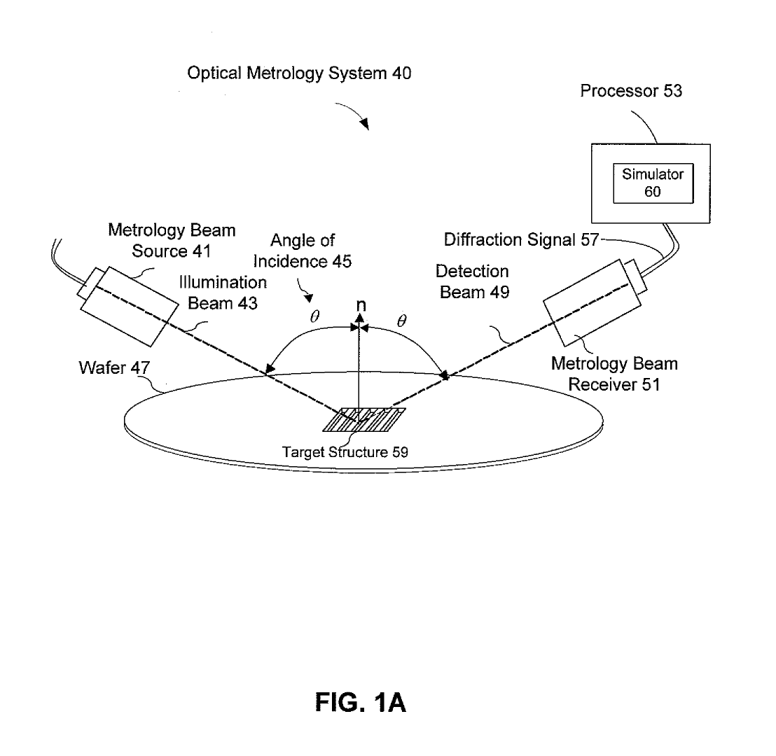

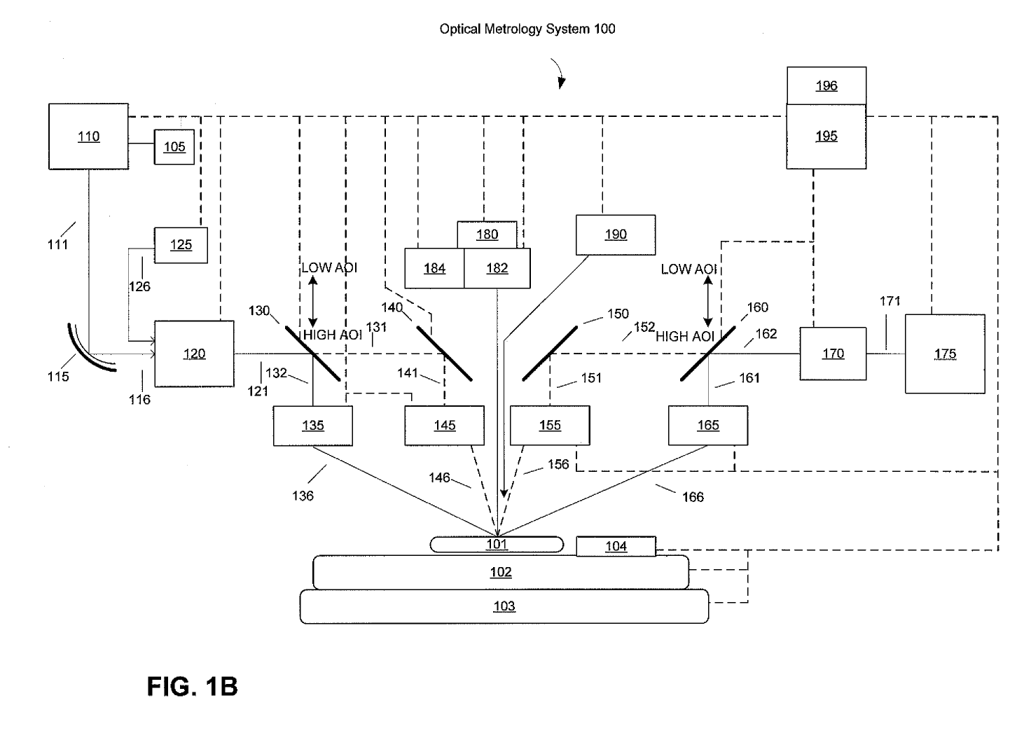

FIG. 1A is an architectural diagram illustrating an exemplary embodiment where optical metrology can be utilized to determine the profiles or shapes of structures fabricated on a semiconductor wafer. The optical metrology system 40 includes a metrology beam source 41 projecting a metrology illumination beam 43 at the target structure 59 of a wafer 47. The metrology illumination beam 43 is projected at an incidence angle 45 (θ) towards the target structure 59. The diffracted detection beam 49 is measured by a metrology beam receiver 51. A measured diffraction signal 57 is transmitted to a processor 53. The processor 53 compares the measured diffraction signal 57 against a simulator 60 of simulated diffraction signals and associated hypothetical profiles representing varying combinations of critical dimensions of the target structure and resolution. The simulator can be either a library that consists of a machine learning system, pre-generated data base and the like (this is library method), or on demand diffraction signal generator that solves the Maxwell equation for a given profile (this is regression method). In one exemplary embodiment, the simulated diffraction signal generated by the simulator 60 best matching the measured diffraction signal 57 is selected. The hypothetical profile and associated critical dimensions of the selected simulator 60 instance are assumed to correspond to the actual cross-sectional shape and critical dimensions of the features of the target structure 59. The optical metrology system 40 may utilize a reflectometer, an ellipsometer, or other optical metrology device to measure the diffraction beam or signal. An optical metrology system is described in U.S. Pat. No. 6,913,900, entitled GENERATION OF A LIBRARY OF PERIODIC GRATING DIFFRACTION SIGNAL, issued on Sep. 13, 2005, which is incorporated herein by reference in its entirety.

Simulated diffraction signals can be generated by applying Maxwell's equations and using a numerical analysis technique to solve Maxwell's equations. It should be noted that various numerical analysis techniques, including variations of rigorous coupled wave analysis (RCWA), can be used. For a more detail description of RCWA, see U.S. Pat. No. 6,891,626, titled CACHING OF INTRA-LAYER CALCULATIONS FOR RAPID RIGOROUS COUPLED-WAVE ANALYSES, filed on Jan. 25, 2001, issued May 10, 2005, which is incorporated herein by reference in its entirety.

Simulated diffraction signals can also be generated using a machine learning system (MLS). Prior to generating the simulated diffraction signals, the MLS is trained using known input and output data. In one exemplary embodiment, simulated diffraction signals can be generated using an MLS employing a machine learning algorithm, such as back-propagation, radial basis function, support vector, kernel regression, and the like. For a more detailed description of machine learning systems and algorithms, see U.S. patent application Ser. No. 10/608,300, titled OPTICAL METROLOGY OF STRUCTURES FORMED ON SEMICONDUCTOR WAFERS USING MACHINE LEARNING SYSTEMS, filed on Jun. 27, 2003, which is incorporated herein by reference in its entirety.

FIG. 1B shows an exemplary block diagram of an optical metrology system in accordance with embodiments of the invention. In the illustrated embodiment, an optical metrology system 100 can comprise a lamp subsystem 105, coupled to an illuminator subsystem 110. At least two optical outputs 111 from the illuminator subsystem 110 can be transmitted to a selector subsystem 115. The selector subsystem 115 can send at least two signals 116 to a beam generator subsystem 120. In addition, a reference subsystem 125 can be used to provide at least two reference outputs 126 to the beam generator subsystem 120. The wafer 101 is positioned using an X-Y-Z-theta stage 102 where the wafer 101 is adjacent to a wafer alignment sensor 104, supported by a platform base 103.

The optical metrology system 100 can comprise a first selectable reflection subsystem 130 that can be used to direct at least two outputs 121 from the beam generator subsystem 120 as outputs 131 when operating in a first mode “LOW AOI” or as outputs 132 when operating in a second mode “HIGH AOI”. When the first selectable reflection subsystem 130 is operating in the first mode “LOW AOI”, at least two of the outputs 121 from the beam generator subsystem 120 can be directed to a first reflection subsystem 140 as output 131, and at least two outputs 141 from the first reflection subsystem can be directed to a low angle focusing subsystem 145, When the first selectable reflection subsystem 130 is operating in the second mode “HIGH AOI”, at least two of the outputs 121 from the beam generator subsystem 120 can be directed to a high angle focusing subsystem 135 as outputs 132. Alternatively, other modes in addition to “LOW AOI” and “HIGH AOI” may be used and other configurations may be used.

When the optical metrology system 100 is operating in the first mode “LOW AOI”, at least two of the outputs 146 from the low angle focusing subsystem 145 can be directed to the wafer 101. For example, a high angle of incidence can be used. When the optical metrology system 100 is operating in the second mode “HIGH AOI”, at least two of the outputs 136 from the high angle focusing subsystem 135 can be directed to the wafer 101. For example, a high angle of incidence can be used. Alternatively, other modes may be used and other configurations may be used.

The optical metrology system 100 can comprise a high angle collection subsystem 155, a high angle collection subsystem 165, a second reflection subsystem 150, and a second selectable reflection subsystem 160.

When the optical metrology system 100 is operating in the first mode “LOW AOI”, at least two of the outputs 156 from the wafer 101 can be directed to the low angle collection subsystem 155. For example, a low angle of incidence can be used. In addition, the low angle collection subsystem 155 can process the outputs 156 obtained from the wafer 101 and low angle collection subsystem 155 can provide outputs 151 to the second reflection subsystem 150, and the second reflection subsystem 150 can provide outputs 152 to the second selectable reflection subsystem 160. When the second selectable reflection subsystem 160 is operating in the first mode “LOW AOI” the outputs 152 from the second reflection subsystem 150 can be directed to the analyzer subsystem 170. For example, at least two blocking elements can be moved allowing the outputs 152 from the second reflection subsystem 150 to pass through the second selectable reflection subsystem 160 with a minimum amount of loss.

When the optical metrology system 100 is operating in the second mode “HIGH AOI”, at least two of the outputs 166 from the wafer 101 can be directed to the high angle collection subsystem 165. For example, a high angle of incidence can be used. In addition, the high angle collection subsystem 165 can process the outputs 166 obtained from the wafer 101 and high angle collection subsystem 165 can provide outputs 161 to the second selectable reflection subsystem 160. When the second selectable reflection subsystem 160 is operating in the second mode “HIGH AOI” the outputs 162 from the second selectable reflection subsystem 160 can be directed to the analyzer subsystem 170.

When the optical metrology system 100 is operating in the first mode “LOW AOI”, low incident angle data from the wafer 101 can be analyzed using the analyzer subsystem 170, and when the optical metrology system 100 is operating in the second mode “HIGH AOI”, high incident angle data from the wafer 101 can be analyzed using the analyzer subsystem 170.

Optical metrology system 100 can include at least two measurement subsystems 175. At least two of the measurement subsystems 175 can include at least two detectors such as spectrometers. For example, the spectrometers can operate from the Deep-Ultra-Violet to the visible regions of the spectrum.

The optical metrology system 100 can include at least two camera subsystems 180, at least two illumination and imaging subsystems 182 coupled to at least two of the camera subsystems 180. In addition, the optical metrology system 100 can also include at least two illuminator subsystems 184 that can be coupled to at least two of the imaging subsystems 182.

In some embodiments, the optical metrology system 100 can include at least two auto-focusing subsystems 190. Alternatively, other focusing techniques may be used.

At least two of the controllers (not shown) in at least two of the subsystems (105, 110, 115, 120, 125, 130, 135, 140, 145, 150, 155, 160, 165, 170, 175, 180, 182 and 190) can be used when performing measurements of the structures. A controller can receive real-signal data to update subsystem, processing element, process, recipe, profile, image, pattern, and/or model data. At least two of the subsystems (105, 110, 115, 120, 125, 130, 135, 140, 145, 150, 155, 160, 165, 170, 175, 180, 182 and 190) can exchange data using at least two Semiconductor Equipment Communications Standard (SECS) messages, can read and/or remove information, can feed forward, and/or can feedback the information, and/or can send information as a SECS message. Controller 195 can include coupling means 196 that can be used to couple the metrology system 100 to other systems in a factory environment.

Those skilled in the art will recognize that at least two of the subsystems (105, 110, 115, 120, 125, 130, 135, 140, 145, 150, 155, 160, 165,170, 175, 180, 182 and 190) can include computers and memory components (not shown) as required. For example, the memory components (not shown) can be used for storing information and instructions to be executed by computers (not shown) and may be used for storing temporary variables or other intermediate information during the execution of instructions by the various computers/processors in the optical metrology system 100. At least two of the subsystems (105, 110, 115, 120, 125, 130, 135, 140, 145, 150, 155, 160, 165, 170, 175, 180, 182 and 190) can include the means for reading data and/or instructions from a computer readable medium and can comprise the means for writing data and/or instructions to a computer readable medium. The optical metrology system 100 can perform a portion of or all of the processing steps of the invention in response to the computers/processors in the processing system executing at least two sequences of at least two instructions contained in a memory and/or received in a message. Such instructions may be received from another computer, a computer readable medium, or a network connection. In addition, at least two of the subsystems (105, 110, 115, 120, 125, 130, 135, 140, 145, 150, 155, 160, 165, 170, 175, 180, 182 and 190) can comprise control applications, Graphical User Interface (GUI) components, and/or database components.

It should be noted that the beam when the optical metrology system 100 is operating in the first mode “LOW AOI” with a low incident angle data from the wafer 101 all the way to the measurement subsystems 175, (output 166, 161, 162, and 171) and when the optical metrology system 100 is operating in the second mode “HIGH AOI” with a high incident angle data from the wafer 101 all the way to the measurement subsystems 175, (output 156, 151, 152, 162, and 171) is referred to as diffraction signal(s).

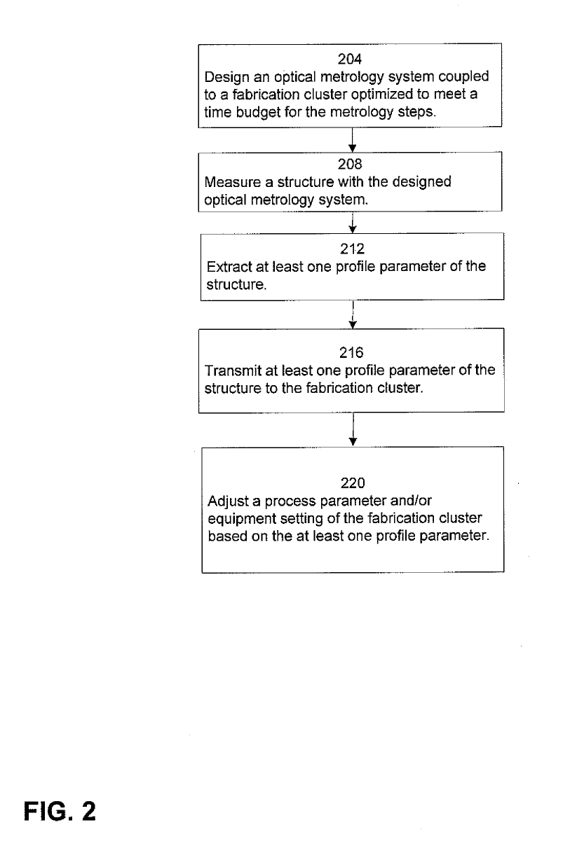

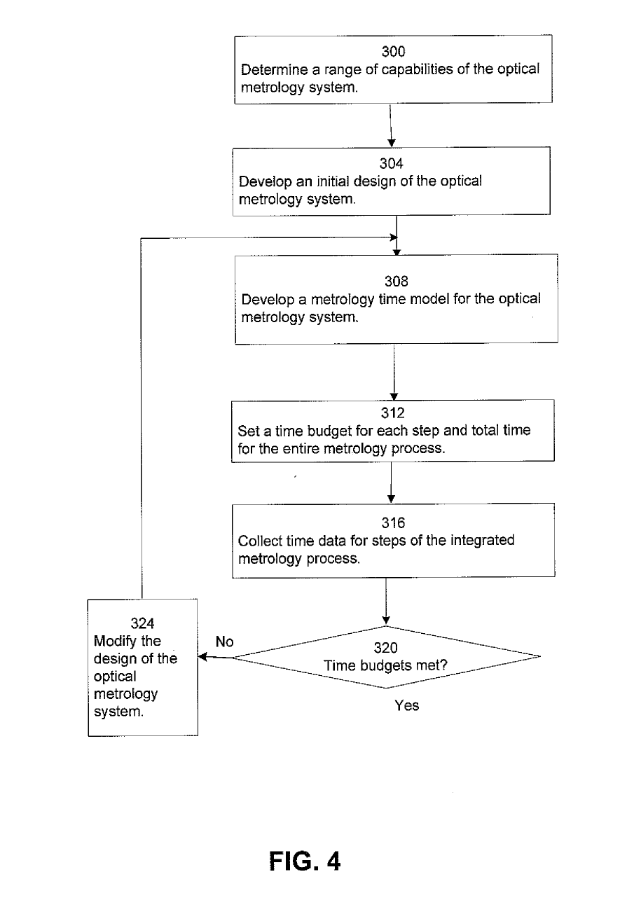

FIG. 2 depicts an exemplary flowchart for designing an optical metrology system for extracting structure profile parameters and controlling a fabrication process for semiconductors. In this exemplary embodiment, the optical metrology system is integrated in a semiconductor fabrication cluster. In step 204, an optical metrology system coupled to a semiconductor fabrication cluster is designed to meet a time budget for the metrology steps. The fabrication cluster may be a lithography, etch, cleaning, chemical-mechanical polishing fabrication cluster, deposition cluster, or the like. The optical metrology system includes an optical metrology tool such as a spectroscopic reflectometer, spectroscopic ellipsometer, hybrid optical device, and the like. The detail steps for designing the optical metrology system are included in the description associated with the flowchart in FIG. 4.

Still referring to FIG. 2, in step 208, a structure is measured with the designed optical metrology system generating a diffraction signal. As mentioned above, the workpiece may be a wafer, a substrate, disk, or the like. In step 212, at least one profile parameter of the structure is extracted from the measured diffraction signal using the methods and systems such as regression, the library method or machine learning systems described above. In step 216, the at least one profile parameter of the structure extracted is transmitted to the fabrication cluster. Extracted profile parameters may include critical dimensions such as bottom width, top width or sidewall angle of the structure. In step 220, at least one process parameter or equipment setting of the fabrication cluster is adjusted based on the transmitted profile parameters.

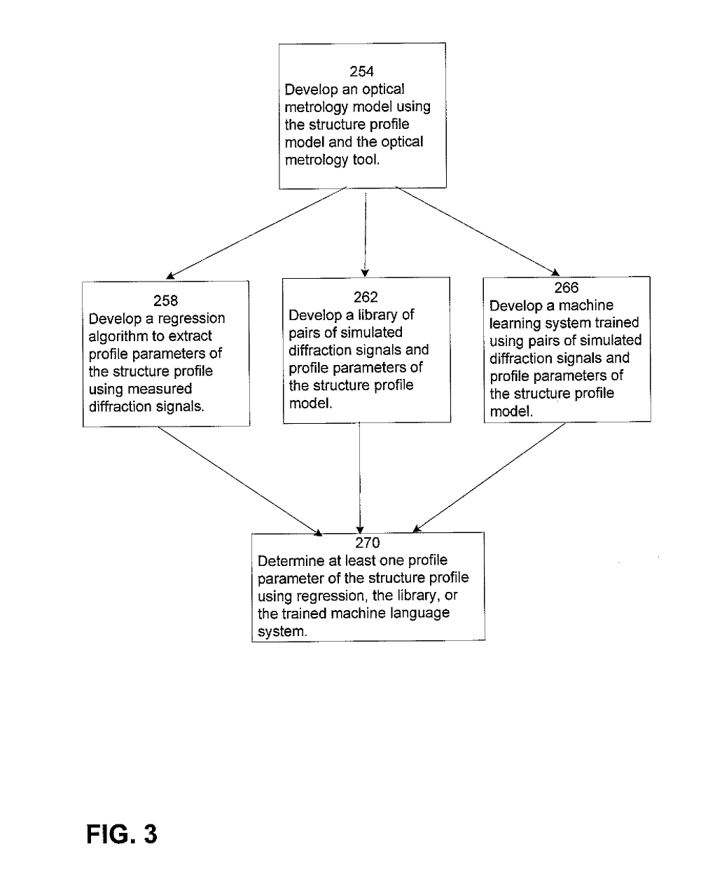

FIG. 3 depicts an exemplary flowchart for designing a sub-system for extracting structure profile parameters. In step 254, an optical metrology model is developed using the profile model of the structure and the designed optical metrology system. As mentioned above, the profile of the structure may be a simple line and space grating or a more complex group of repeating structures such as posts, contact holes, vias, or combinations of different shapes structures in a repeating pattern of unit cells. For a detailed description of modeling two-dimensional repeating structures, refer to U.S. patent application Ser. No. 11/061,303, OPTICAL METROLOGY OPTIMIZATION FOR REPETITIVE STRUCTURES, by Vuong, et al., filed on Apr. 27, 2004, and is incorporated in its entirety herein by reference. The optical metrology model includes characterization of the illumination beam that is used to illuminate the structure and characterization of the detection beam diffracted from the structure.

In step 258, a regression algorithm is developed to extract the profile parameters of the structure profile using measured diffraction signals. Typically, the regression algorithm compares a series of simulated diffraction signals generated from a set of profile parameters where the simulated diffraction signal is matched to the measured diffraction signal until the matching criteria are met. For a more detailed description of a regression-based process, see U.S. Pat. No. 6,785,638, titled METHOD AND SYSTEM OF DYNAMIC LEARNING THROUGH A REGRESSION-BASED LIBRARY GENERATION PROCESS, filed on Aug. 6, 2001, which is incorporated herein by reference in its entirety.

In step 262, a library of pairs of simulated diffraction signals and profile parameters of the structure are generated. For a more detailed description of an exemplary library-based process, see U.S. Pat. No. 6,943,900, titled GENERATION OF A LIBRARY OF PERIODIC GRATING DIFFRACTION SIGNALS, issued on Sep. 13, 2005, which is incorporated herein by reference in its entirety. In step 266, an MLS is trained using pairs of simulated diffraction signals and profile parameters. The trained MLS is configured to generate a set of profile parameters as output based on an input measured diffraction signal. For a more detailed description of a generating and using a trained MLS, see U.S. Pat. No. 7,280,229, titled EXAMINING A STRUCTURE FORMED ON A SEMICONDUCTOR WAFER USING MACHINE LEARNING SYSTEMS, filed on Dec. 3, 2004, which is incorporated herein by reference in its entirety. In step 270, at least one profile parameter of the structure profile is determined using the regression algorithm, the library, or the trained MLS. It should be noted that the steps described above, (254, 258, 262, 264, and 268), apply to an optical metrology system in a fabrication cluster or to a standalone optical metrology system.

FIG. 4 depicts an exemplary flowchart for optimizing the design of an optical metrology system based on achieving a time budget for the metrology steps. In step 300, the range of capabilities of the optical metrology system is determined. The range of capabilities of the optical metrology system may include the types of wafer applications that can be measured which in turn determines the number of measurement beams and optical paths, the range of illumination beam angle of incidence, number of measurement sites per wafer, the number of measurements per site, and the like. In step 304, an initial design of the optical metrology system is developed based on the range of capabilities determined in the step 300. The initial design includes components of the optical metrology system comprising at least two light sources, focusing optics for the at least two illumination beams, at least two polarizers for the illumination beams, collecting optics for the at least two detection beams, a motion control system for positioning the workpiece, at least two detectors for measuring the diffraction signals, a first processor for converting the measured diffraction output to diffraction data, data storage for storing profile parameter extraction algorithms, libraries, or trained machine learning systems, and a second processor for extracting at least one parameter of the structure from the diffraction signal. For example, if the range of capabilities includes measurement of basic structures only, then two or more illumination beams at one angle of incidence may be selected. Conversely, if the range of capabilities includes basic structures and complicated three dimensional structures, then two or more beams operable in a range of angles of incidence may be selected.

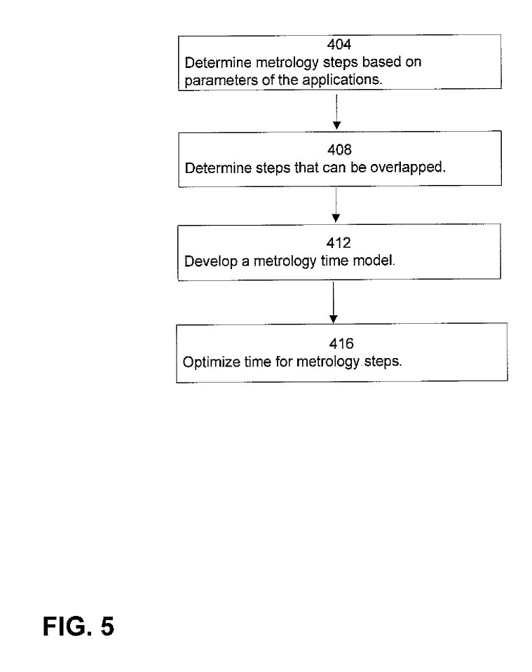

In step 308, a metrology time model for the metrology system is developed. Components of the metrology time model for semiconductor wafer applications comprise serial actions including elements for the robot to perform wafer swap, for activating the vacuum subsystem, for the motion control system to perform coarse wafer alignment, for moving the wafer to the center of the pattern recognition site, for fine wafer alignment, for moving the wafer to an unload position, for deactivating the vacuum subsystem, for completing the first diffraction signal acquisition, and for completing subsequent diffraction signal acquisitions. Many other metrology steps are involved; however, these may be completed in parallel or overlapped with other metrology steps. The details of developing a metrology time model are described in relation to FIG. 5 that follows.

Referring to FIG. 5, an exemplary flowchart is depicted for developing and optimizing the time needed to complete an optical metrology measurement process. As mentioned above, although the exemplary embodiment utilizes a wafer for the workpiece, the principles and concepts apply to other workpieces. In step 404 of FIG. 5, the metrology steps based on types of applications to be measured are determined. Types of applications are characterized by specifying the number of pattern recognition sites required, the range of number of measurement sites, motion paths for the wafer, and the like. In step 408, the steps that can be performed in parallel or overlapped are determined. For example, turning on the vacuum on the chuck to secure the wafer and rotating the wafer to find the alignment notch are steps that are done in series, i.e., the steps are not overlapped. Similarly during fine alignment of the wafer, moving the wafer to a pattern recognition site and subsequent pattern recognition processing are not overlapped. Sending the acquired diffraction signal to a processor for determination of at least one profile parameter of the structure, closing the shutter of the filter optics, and rotating back the polarizer can generally be overlapped with other metrology steps. Based on the determined metrology steps and whether or not a step can be overlapped with other steps, a metrology time model is developed, step 412. The time model basically includes a set of metrology steps that must be done in sequence and cannot be overlapped. In addition, any variable that determines the length of time for a particular step or algorithm to determine the length of time the same step is included in the model for the configuration of the optical metrology system under consideration. In one embodiment, the time model can include time elements required for metrology steps including wafer swap, turning vacuum on, coarse alignment of wafer, fine alignment of the wafer, movement of the wafer to measurement site, measuring and integrating the structure being measured, rotating the polarizer, rotating the polarizer back, sending the spectrum to the processor, extracting at least one profile parameter from the diffraction signal, moving the wafer to an unload position, and turning the vacuum off.

In step 416, the time for metrology steps are optimized. Optimization can be done by iterating a manual procedure of summing up the time for all the metrology steps that cannot be overlapped, or semi-automatically such as through the use of spreadsheet software or through the use of custom algorithms where possible combinations of different settings of a particular device are used and/or a different path of the wafer is utilized, and/or a different number of pattern recognition sites are used. For example, a manual procedure can include a list of metrology process steps and substituting time values for the metrology process steps based on assumptions of speed for certain steps obtained from experiments or from the vendors specifications sheets. The total time for all the metrology steps that are not overlapped are added up and one that generates the least total time is noted. In another embodiment, given a series of measurement sites on a wafer such as 5, 7, 9, 1, 13, and 17-measurement sites, the total measurement time is influenced by the number of pattern recognition sites used. Typically, a minimum of 2 pattern recognition sites may be sufficient if the notch finding step is highly accurate. Other embodiments can utilize 3 or more pattern recognition sites, a pattern recognition site measurement per new measurement site, or use of X-Y-theta motion instead of X-Y motion in the motion control system. Different motion paths of the wafer based on the number of measurement sites and number of pattern recognition measurements used may yield different total times for completion of metrology steps. Total time is calculated for the different combinations and the lowest total time is identified as the optimum.

Referring back to FIG. 4, in step 312, a time budget for each metrology step that is performed in series or a total time budget for completing all the metrology steps for a workpiece are set. For example, the time budget to perform a coarse alignment of a wafer may be set at 1 second and the total time budget to complete all the metrology steps of a wafer with seven measurement sites may be set at 12 seconds. Another example is where the time budget for rotating a polarizer is set at 0.20 seconds and the total time budget to complete all the metrology steps of wafer with eleven sites may be set at 15 seconds. In step 316, the time for performing a metrology step or the time for completing all the metrology steps for a workpiece are collected. Time data for the steps may be collected using a breadboard model of the optical metrology system or by using the vendor specifications for components of the optical metrology system.

In step 320 of FIG. 4, the collected time for each metrology process step and/or the total budget time to complete the entire metrology process are compared to their respective time budgets. If the completion time criterion is not met or the completion time criteria are not met, in step 324, the design of the optical metrology system is modified and steps 308, 312, 316, 320, and 324 are iterated until the time budget criterion or criteria are met. If the completion time criterion or criteria are met, then optimizing the design of an optical metrology system based on achieving a time budget for the metrology steps is complete. In another embodiment, only the total time budget for all the metrology steps is set. The total time to complete all the metrology steps are collected and compared to the total time budget. If the time criterion is not met, in step 324, the design of the optical metrology system is modified and steps 308, 312, 316, 320, and 324 are iterated until the total time budget criterion is met.

Modification of the design of the of the optical metrology system can include selecting two or more light sources utilizing different ranges of wavelengths, illuminating the structure at substantially the same spot with the two or more beams from the two or more light sources at the same time, and measuring the two or more diffraction signals off the structure and using a separate detector for each of the two or more diffraction signals instead of one light source; selecting an off-axis reflectometer wherein the angle of incidence of the illumination beam is substantially around 28 degrees instead of a normal or near normal angle of incidence; selecting an off-axis reflectometer wherein the angle of incidence of the illumination beam is substantially around 65 degrees instead of a near normal reflectometer instead of 28 degrees; utilizing a motion control system to position the structure for optical metrology instead of an X-Y-Z stage. In other embodiments, modification of the design of the optical metrology system can include measuring only reflectance or intensities of the diffraction signals instead of measuring reflectance and phase shift of the diffraction signal. In other embodiments, selecting a first polarizer in the illumination path and a second polarizer in the detection path, where the first and second polarizers are configured to increase the signal to noise ratio of the illumination and detection beams respectively instead of regular polarizers or substituting the first polarizer and the second polarizer with polarizers from another vendor and the like.

Still referring to step 324, modification of the design of the of the optical metrology system can also include utilizing different speeds of the motion control system; using reflective optics for focusing illumination beams and collecting detection beams instead of diffractive optics; using a selectable angle of incidence for the illumination beam to optimize accuracy of the diffraction measurement instead of a fixed angle of incidence of the illumination beams; selecting a new profile parameter extraction algorithm; and performing the profile parameter extraction using diffraction signals measured off the structure using the optical metrology system and a processor; modifying the processor to use parallel processing of computer tasks to perform the selected profile parameter extraction algorithm instead of serial processing; switching the profile extraction algorithm to a regression algorithm, a library extraction algorithm, or a machine learning system algorithm; revising the machine learning system algorithm to use pairs of simulated diffraction signals and corresponding profile parameters with a reduced number of floating profile parameters for training the machine learning system; and/or substituting the spectrometers with spectrometers from another vendor. In another embodiment, the design of the optical metrology system is modified to reduce the total alignment time by eliminating the coarse alignment step and performing the coarse and fine alignment steps with the wafer positioned on the chuck. It is understood that any change in the design of the optical metrology system that can reduce the time for a metrology step or steps can be included in the list of design changes for step 324.

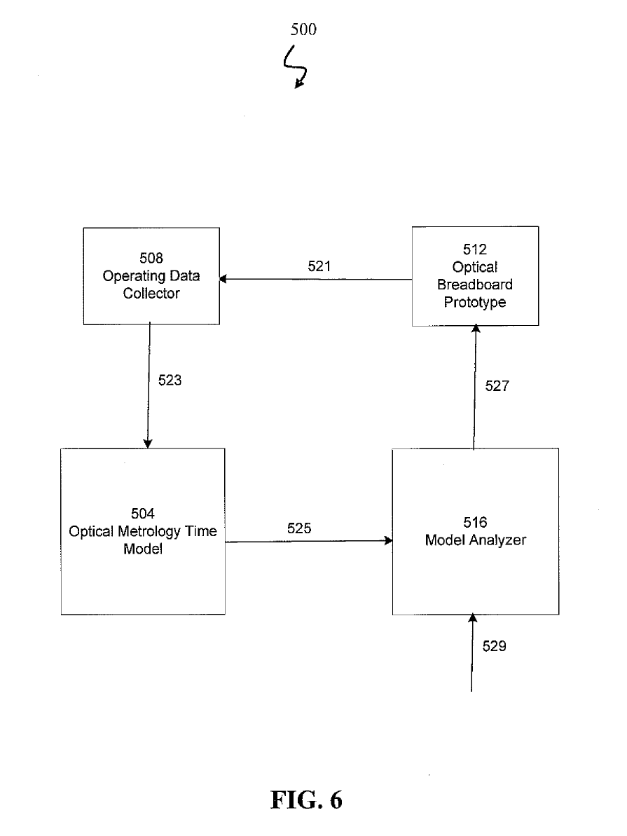

FIG. 6 is an exemplary block diagram of a system 500 to optimize the time needed to complete an optical metrology measurement process. The system comprises an optical metrology time model 504, an operating data collector 508, an optical breadboard prototype 512, and a model analyzer 516 are coupled to collect and optimize the time performance of a particular design of the optical measurement process. The optical metrology time model 504 includes algorithms for calculating the time needed for metrology steps depending on the specific type of component selected for a function. As mentioned above, the metrology steps of the optical metrology measurement process include wafer swap, turning vacuum on, coarse alignment of wafer, fine alignment of wafer, move to measurement site, measure and integrate, rotate polarizer, rotate polarizer back, sending the spectrum to processor, extracting the profile parameters including a critical dimension of the structure, moving the wafer to the unload position, and turning the vacuum off. The fine alignment of the wafer may include steps of moving the wafer or the optical device to the first pattern recognition site, actually doing the pattern recognition of the first pattern recognition site, moving the wafer to the second pattern recognition site, actually doing the pattern recognition of the second pattern recognition site, and so on until all the pattern recognition sites are completed.

Still referring to FIG. 6, the breadboard prototype 512 comprises optical metrology system components that are coupled to simulate the performance of the actual optical metrology system. In an optical breadboard prototype for an optical metrology system, many of the actual optical components are utilized to test out the optical path and connections between mechanical and electronic components. In another embodiment, the optical breadboard prototype may be a completed test model of the optical metrology system. For example, the fine alignment of the wafer may include a motion control system (not shown) programmed to move the wafer to the selected sites and a pattern recognition system (not shown) coupled to the motion control system. The raw time data 521 to complete the metrology step in the optical breadboard prototype 512 is transmitted to the operating data collector 508 and collections of raw time data 523 for the different metrology steps are further sent to the optical metrology time model 504. The collections of raw time data 523 is processed by the optical metrology time model 504 to generate the time for each metrology steps and a total time 525 for all the metrology steps and is transmitted to the model analyzer 516. The model analyzer 516 compares the individual time of the metrology steps and/or the total time 525 for all the metrology steps with ranges of time budgets 529 for each metrology step and the total time budget 527. Based the total time budget 527, a throughput such as wafers per hour for the metrology system may be calculated. For example, an optical metrology system with a desired throughput of 180 wafers per hour must complete all the metrology steps in 20 seconds or less and a throughout of 200 wafers per hour must complete all the metrology steps in 16 seconds or less.

In another embodiment, the optical metrology system is designed to meet a throughput criterion instead of a time budget. For example, if the workpiece is a semiconductor wafer, the operating criterion may be stated in terms of wafers measured per hour. Another variation is where the operating criterion is expressed as number of wafers per hour with a specified number of sites measured on the wafer. For example, if an application is designed to need only 5 measurement sites, the throughput rate would be higher that if the application requires a minimum of 9 measurement sites. Another variation is where the wafers per hour in an integrated metrology system is different from the wafers per hour in a standalone metrology system. Depending on the number of wafer in a cassette and degree of automation, the wafers per hour may be different in a standalone metrology operation compared to an integrated metrology operation.

Although exemplary embodiments have been described, various modifications can be made without departing from the spirit and/or scope of the present invention. For example, the elements required for the design of the optical metrology system are substantially the same whether the optical metrology system is integrated in a fabrication cluster or used in a standalone metrology setup. Therefore, the present invention should not be construed as being limited to the specific forms shown in the drawings and described above.

What is claimed:

1. A method of designing an optical metrology system, the optical metrology system measuring structures on a workpiece, the optical metrology system configured to achieve a metrology time budget, the method comprising:
a) developing an initial design of the optical metrology system with selected components and component specifications;
b) setting a time budget for steps of a metrology process and/or a total time budget for all the steps of the metrology process;
c) collecting time data required to perform steps of the metrology process;
d) if the collected time data do not meet the time budget for the steps of the metrology process, modifying the design of the optical metrology system and iterating steps (b), (c), and (d) until the collected time data meet the time budget.

2. The method of claim 1 wherein the workpiece is a wafer in a semiconductor application.

3. The method of claim 2 wherein collecting time data needed to perform steps of the metrology process comprises:
collecting time data for positioning the wafer for measurement in the metrology system;
collecting time data for performing alignment of structures to be measured on measurement sites on the wafer;
collecting time data for measuring diffraction signals off the structures on measurement sites on the wafer;
collecting time data for extracting critical dimension of the structures based on the measured diffraction signals; and
collecting time data for unloading the wafer.

4. The method of claim 2 wherein the total time budget for the metrology steps is 20 seconds or less per wafer.

5. The method of claim 2 wherein the total time budget for the metrology steps is 16 seconds or less per wafer.

6. The method of claim 1 wherein modifying the design of the optical metrology system comprises:
selecting two or more light sources utilizing different ranges of wavelengths, illuminating the structures at substantially the same spot with the two or more beams from the two or more light sources at the same time, and measuring two or more diffraction signals off the structures and using a separate detector for each of the two or more diffraction signals.

7. The method of claim 1 wherein modifying the design of the optical metrology system comprises:
selecting an off-axis reflectometer wherein the angle of incidence of one or more illumination beams of the reflectometer are substantially around 28 degrees or selecting an off-axis reflectometer wherein the angle of incidence of one or more illumination beams of the reflectometer are substantially around 65 degrees.

8. The method of claim 1 wherein modifying the design of the optical metrology system comprises:
utilizing a motion control system to position the structures for optical metrology, the motion control system having X-Y-Z-Theta movement capability.

9. The method of claim 1 wherein modifying the design of the optical metrology system comprises:
measuring only intensities of diffraction signals and utilizing a profile parameter extraction algorithm based on diffraction signal intensities.

10. The method of claim 1 wherein modifying the design of the optical metrology system comprises:
selecting a first polarizer in an illumination path and a second polarizer in a detection path, wherein the first and second polarizers are configured to increase the signal to noise ratio of an illumination beam in the illumination path and a detection beam in the detection path.

11. The method of claim 1 wherein modifying the design of the optical metrology system comprises:
using reflective optics for focusing illumination beams and collecting detection beams.

12. The method of claim 1 wherein modifying the design of the optical metrology system comprises:
configuring the angle of incidence for an illumination beam to optimize accuracy of a diffraction measurement.

13. The method of claim 3 wherein the extraction of critical dimension of the structures based on the measured diffraction signals comprises:
selecting a profile parameter extraction algorithm; and
performing a profile parameter extraction using diffraction signals measured off the structures using the optical metrology system and a processor.

14. The method of claim 14 wherein performing the profile parameter extraction comprises:
modifying the processor to use parallel processing of computer tasks to perform the selected profile parameter extraction algorithm.

15. The method of claim 14 wherein modifying the design of the optical metrology system comprises:
switching the profile extraction algorithm to a regression algorithm, a library extraction algorithm, or a machine learning system algorithm.

16. The method of claim 1 wherein modifying the design of the optical metrology system comprises:
revising the sequence of the metrology steps from utilizing three pattern recognition motion paths to utilizing two pattern recognition motion paths.

17. The method of claim 1 wherein modifying the design of the optical metrology system comprises:
revising alignment metrology steps to eliminate coarse alignment using a prealigner and to perform coarse and fine alignment of the workpiece while the workpiece is on a chuck.

18. The method of claim 1 wherein modifying the design of the optical metrology system comprises:
utilizing a different motion path for the workpiece wherein the motion path is optimized for a set number of measurement sites on the workpiece.

19. The method of claim 1 wherein the workpiece is a wafer in a semiconductor application and the optical metrology system is integrated into a fabrication cluster.

20. The method of claim 1 wherein the workpiece is a wafer in a semiconductor application and the optical metrology system is part of a standalone metrology device.
